(19) United States
(12) Patent Application Publication
(10) Pub. No.: US 2011/0005804 A1
(43) Pub. Date: Jan. 13, 2011

(54) INTERNALLY SERRATED INSULATION FOR ELECTRICAL WIRE AND CABLE

(75) Inventor: John G. Nickence, Pleasant Prairie, WI (US)

Correspondence Address: HONEYWELL/HUSCH;Patent Services, 101 Columbia Road, P.O.Box 2245, Morrlstown, NJ, 07962, US

(73) Assignee: Honeywell International Inc., Morristown, NJ (US)

(21) Appl. No.: 12/500,217

(22) Filed: Jul. 9, 2009

(51) Int. Cl. H01B 3/30; B23P 19/00

(52) U.S. Cl. 174/110 R; 29/745

(57) ABSTRACT

A coaxial cable has a conducting shield covered by a jacket. The jacket defies spaced apart, axially extending voids adjacent to the shield. The voids separate axially extending contact regions of the jacket which extend axially and in contact with the shield. The voids and the contact regions are linked circumferentially by a continuous closed curve.

### FIELD

The invention pertains to electrical wire and cable. More particularly, the invention pertains to wire or cable formed with an external, insulating sheath that has an interior cylindrical undulating surface which only contacts an adjacent internal conductor at spaced apart regions.

### BACKGROUND

Known types of coaxial cable have an interior conductor, an insulating core, an overlying metallic braid and an overlying jacket or outer cover. The braided core consists of copper strands braided tightly around the core. The purpose of this braid is to provide a shield against electrical noise. The braid shields the cable preventing any electrical noise from being induced onto the conductor. Any electrical noise will have a negative impact on the performance of the cable.

The jacket is commonly extruded over an exterior surface of the cable core. In one form, the extrusion tooling has a smooth round tip, which maintains a smooth tight inner surface, and a smooth round die, which produces the smooth outer texture of the cable, to process the insulating compounds over the braided core. This causes the jacket to be tight against the braid 360° around the braided core. The jacket can be extruded tight enough around the braided core that the braided core will leave braid pattern impressions on the inside surface of the jacket. This arrangement also impacts the process of attaching connectors to such cables as the braid needs to be accessible to the connector.

The above types of cables are usually manufactured to meet all Underwriters Laboratory (UL) requirements for wire and cable. UL specifies a minimum, maximum, minimum average and an absolute minimum at any point wall thickness of the external sheath. Two important parameters are the minimum average and the absolute minimum at any point. If the cable meets the minimum average and the absolute minimum at any point it will satisfy any of the other conditions. The maximum thickness parameter, of course, impacts material requirements and usage. In order to try to minimize usage of materials the wall thickness should be as close as possible to the minimum average and the absolute minimum wall thicknesses.

### BRIEF DESCRIPTION OF THE DRAWINGS

FIG. 1 is an isometric view, partly in section and partly broken away of a portion of a cable which embodies the invention;

FIG. 2 is a view in section, perpendicular to an axis of the cable of FIG. 1;

FIG. 2A illustrates alternate embodiment to that of FIGS. 1, 2;

FIG. 3 is an isometric view illustrating aspects of an alternate to the cable of FIG. 1; and

FIGS. 4A-D are a sequence of sectional views illustrating details of attaching a connector to a cable of the type of FIG. 1 or FIG. 3.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In one aspect of the invention, serrations can be formed on the inside of the jacket or external insulating sheath of an insulated electrical wire or cable. In embodiments of the invention, the serrations are formed in a pattern that will maintain the minimum wall requirements of UL and which will not reduce the insulating properties of the jacket.

The average wall thicknesses are measured from a cross sectional cut of the wire. Measurements are taken 180 degrees apart from each other and averaged for the average wall thickness. The thinnest parts due to the serrations are place such that a serration is 180 opposite of a non-serrated section. Therefore the minimum average wall thicknesses are maintained. The serrations are never so deep as to violate an absolute minimum thickness requirement at any point.

In addition to minimizing material usage to form the external sheath or jacket, wire or cable which embody the invention exhibit enhanced flexibility and the installation of connectors onto the wire or cable is facilitated by less adherence of the sheath to the braid.

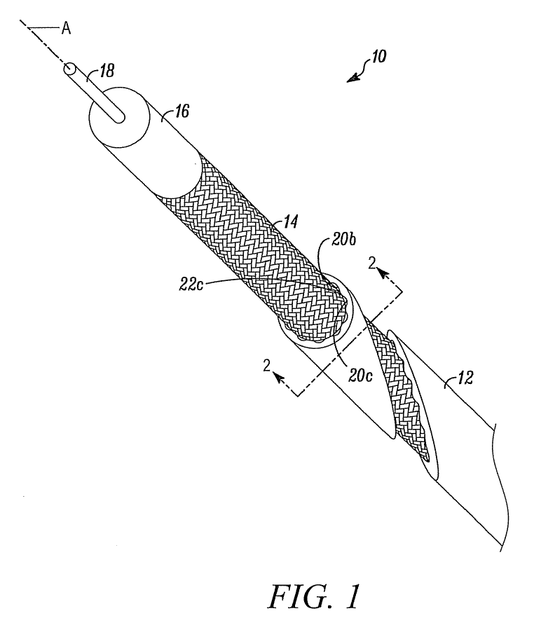

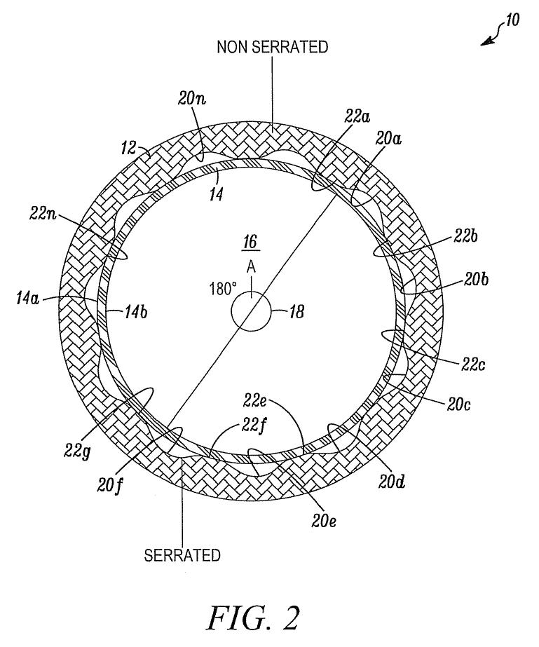

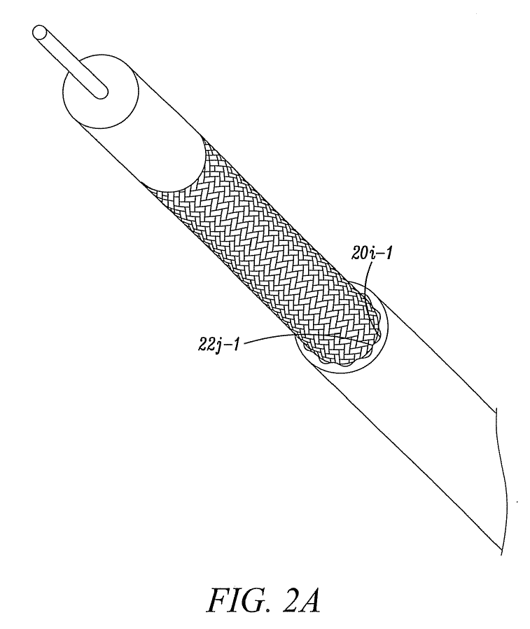

FIGS. 1, 2 illustrate aspects of an embodiment of the invention. A coaxial cable 10 is formed with an external extruded insulating outer sheath 12. Sheath 12 surrounds and protects a metallic braid or shield 14.

Braid 14 in turn surrounds a cylindrical insulating element 16 which in turn surrounds an interior conductor, which could be implemented as a solid metal, or stranded, wire, 18. The cable 10 is formed generally symmetrically, except as discussed below, about a common axis A.

As further illustrated in FIGS. 1, 2 serrations, or voids 20a, b, c . . . n are preferably formed as sheath 12 is extruded over braid 14. The serrations, such as 20i are bounded by adjacent regions, such as contact regions 22i, 22j which abut and are in contact with an exterior surface 14a of braid 14. Preferably, to provide a minimum average thickness parameter, as discussed above, protruding, contact region 22a is 180 degrees out of phase with void 20f.

By patterning the voids, such as 20i and contact regions such as 22n so as to be oppositely located relative to one another the minimum wall requirements of a standards organization such as UL can be met while reducing materials cost for the jacket, increasing cable flexibility and facilitating easier installation of connectors on the respective cable ends. It will be understood that the void/contact region patterns can take on various shapes without departing from the spirit and scope of the invention.

FIG. 2A illustrates a variation with voids 20i-1 which have a discontinuous cross-section. The voids 20i-1 are spaced apart by contact regions 22j-1 which also have a discontinuous cross-section. Other cross-sectional shapes are possible.

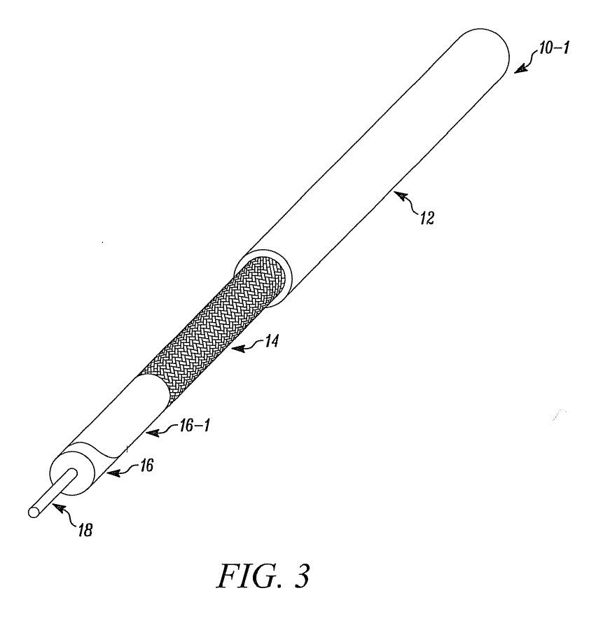

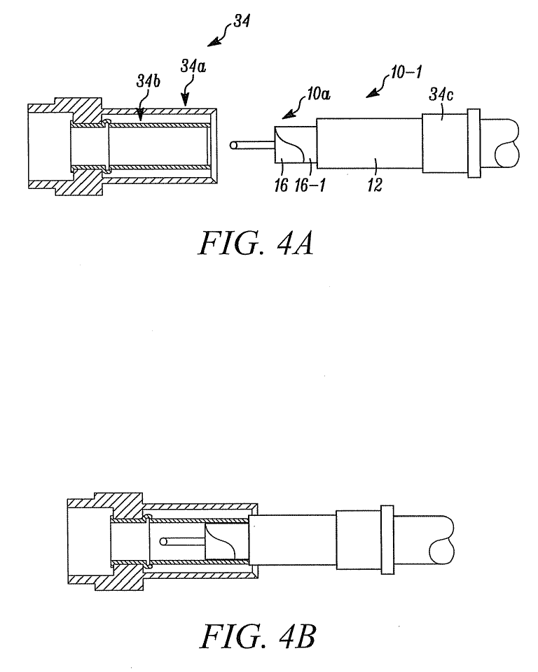

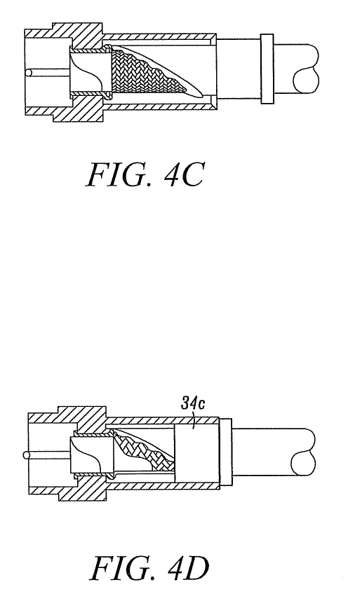

FIGS. 3, 4 illustrate various aspects of a cable 10-1 of the general type of FIGS. 1, 2 with a connector 34 being attached to an end 10a thereof. Elements of the cable 10-1 that correspond to elements of the cable 10 of FIG. 1, 2 have been given the same identification numerals. Cable 10-1 also includes an aluminum foil shield 16-1 that is sandwiched between polyethylene core 16 and braid 14.

A connector 34 includes a barrel 34a, a ferrule 34b, and a locking ring 34c. The ring 34c slides on jacket 12 and engages barrel 34a. An alternative connector type could use a crimpable or compression type barrel in place of the locking ring.

The installation of the connector 34 on the end 10a is facilitated by the presence of voids, such as 20i which reduce adherence of the sheath 12 to braid 14. As a result, as best seen in FIG. 4, the ferrule 34b will slide under the braid 14 and under the portion of the sheath 12, adjacent to the braid 14 and ferrule 34b, with less installation force and potentially cleaner separation of the sheath from the braid 14 in that region.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A multi-element cable comprising:
a cable core; and
a non-conducting exterior jacket which surrounds the cable core where the jacket has an outer surface, relative to the core, an inner surface adjacent to the core and where the inner surface defines a plurality of spaced apart, regions in contact with the core, with voids between the inner surface and the core between the regions.

2. A cable as in claim 1 where the regions, in a plane perpendicular to an axis of the core have a surface defined by a continuously varying closed curve.

3. A cable as in claim 1 where the core and the jacket have adjacent end regions and a connector which has a core engagement portion which is positioned between the end of the region of the jacket and the end region of the core where the engagement portion displaces the region generally radially away from a conductor of the core.

4. A cable as in claim 1 where the inner surface has a generally circular cross-section and the regions are displaced about that cross-section such that first and second radially displaced regions exhibit a minimal thickness parameter and a maximal thickness parameter which are one hundred eighty degrees apart from on another relative to a central axis of the core.

5. A cable as in claim 1 where a cross-sectional shape of the regions is selected from among a continuously varying perimeter, adjacent to the core, or, a discontinuous perimeter, adjacent to the core.

6. A cable as in claim 1 where the core comprises a braded, generally cylindrical, metallic member.

7. A cable as in claim 5 where the core comprises one of a braided, multiple conductor, or a single conductor generally cylindrical member.

8. A cable as in claim 5 which includes a cylindrical insulating member substantially surrounded by the core.

9. A cable as in claim 8 where the core comprises a braided, generally cylindrical, metallic member.

10. A cable as in claim 8 which includes a conductor surrounded by the insulating member.

11. A cable as in claim 10 where the inner surface has a generally circular cross-section and the regions are displaced about that cross-section such that first and second radially displaced regions exhibit a minimal thickness parameter and a maximal thickness parameter which are one hundred eighty degrees apart from on another relative to a central axis of the core.

12. A cable as in claim 11 where the core and the jacket have adjacent end regions and a connector which has a core engagement portion which is positioned between the end region of the jacket and the end region of the core where the engagement portion displaces the regions generally radially away from a central axis of the core.

13. A coaxial cable comprising:
first and second elongated and spaced apart conductors where one conductor is covered, at least in part, by a flexible outer jacket, and, where voids extend axially between the one conductor and the jacket.

14. A cable as in claim 13 where the one conductor surrounds the other and where both conductors and the jacket have a common axis of symmetry.

15. A cable as in claim 14 where the voids extend along the jacket generally parallel to the axis of symmetry.

16. A cable as in claim 15 where the voids are distributed circumferentially around the jacket.

17. A cable as in claim 15 where the voids are spaced apart by axially extending regions where a cross-sectional shape of the regions is selected from among a continuously varying perimeter, adjacent to the conductor, or, a discontinuous perimeter, adjacent to the conductor.

18. A method of forming a cable comprising:
providing a cable core;
applying a jacket to the core and which includes forming circumferentially distributed voids between the core and the jacket.

19. A method as in claim 18 where applying includes extruding the jacket onto the core.

20. A method as in claim 18 which includes forming contact regions between the voids.
